(19) United States
(12) Patent Application Publication
(10) Pub. No.: US 2006/0294346 A1
(43) Pub. Date: Dec. 28, 2006

(54) Method and apparatus for managing a link return stack

(76) Inventors: Brian Michael Stempel, Raleigh, NC (US); James Norris Dieffenderfer, Apex, NC (US); Thomas Andrew Sartorius, Raleigh, NC (US); Rodney Wayne Smith, Raleigh, NC (US)

Correspondence Address: QUALCOMM INCORPORATED, 5775 MOREHOUSE DR., SAN DIEGO, CA, 92121, US

(21) Appl. No.: 11/165,268

(22) Filed: Jun. 22, 2005

(51) Int. Cl. G06F 15/00

(52) U.S. Cl. 712/242

(57) ABSTRACT

In one or more embodiments, a processor includes a link return stack circuit used for storing branch return addresses, wherein a link return stack controller is configured to determine that one or more entries in the link return stack are invalid as being dependent on a mispredicted branch, and to reset the link return stack to a valid remaining entry, if any. In this manner, branch mispredictions cause dependent entries in the link return stack to be flushed from the link return stack, or otherwise invalidated, while preserving the remaining valid entries, if any, in the link return stack. In at least one embodiment, a branch information queue used for tracking predicted branches is configured to store a marker indicating whether a predicted branch has an associated entry in the link return stack, and it may store an index value identifying the specific, corresponding entry in the link return stack.

### BACKGROUND

1. Field of the Invention

The present invention generally relates to microprocessors, and particularly relates to managing hardware link return stacks used by some types of microprocessors for accelerating returns from procedure calls.

2. Relevant Background

Microprocessors find use in a wide variety of products, ranging from high-end computational systems, where processing power represents a paramount design consideration, to low-end embedded systems, where cost, size, and power consumption comprise the primary design considerations. Processors targeted for battery-powered portable devices, such as music players, palmtop computers, Portable Digital Assistants (PDAs), and the like, represent a particularly complex mix of competing design considerations. On the one hand, processor performance must be sufficient to support the device's intended functionality and provide a satisfactory user “experience.” On the other hand, processor power consumption must be low enough to permit the use of reasonably sized battery systems, while achieving acceptable battery life.

The above mix of competing design goals has resulted in numerous processor performance and efficiency advancements. For example, modern pipelined processors, such as those based on a Reduced Instruction Set Computer (RISC) architecture, oftentimes employ a hardware-based link return stack that is used to improve processor performance in the context of program procedure calls and returns based on providing “predicted” branch return addresses that allow a processor's pre-fetch unit to begin caching instructions from a predicted procedure return location in advance of executing the actual procedure return. Indeed, it is possible to fetch and decode the instructions at the return location, such that they are able to execute immediately upon determining that the predicted return address is correct.

More particularly, many higher-performance pipelined processors carry out pre-fetching and procedure return acceleration in concert with branch prediction operations. In branch-predicting processors, the taken/not-taken status of a conditional program branch is predicted before the condition is resolved. Doing so allows processing to continue based on the assumed taken/not-taken status of program branches, which avoids stalling execution of instructions that are in-flight within the processor's pipeline(s) and permits instruction pre-fetching and decoding operations to continue.

However, branch prediction operations introduce potential link return stack problems. For example, a given program branch may be predicted as taken and the corresponding branch return address will be written to the link return stack. If it turns out that the program branch ultimately is not taken, i.e., it was “mispredicted,” then the corresponding return address stored in the link return stack is invalid.

In general, then, branch mispredictions result in the link return stack holding one or more invalid return addresses. However, management of the link return stack is simplified if the invalidity of those entries is ignored and instruction pre-fetching is carried out, even for the invalid branch return addresses. The number of erroneous entries in the link stack may dwindle over time as the older, invalid entries drop off, but prefetching from erroneous addresses harms both machine performance and power efficiency.

One alternative to the above “method” avoids wasting power but, ultimately, forfeits at least some of the performance gains afforded by the link return stack. In this alternative approach, the link return stack is wholly invalidated responsive to detecting a branch misprediction. While that action does prevent instruction pre-fetching from invalid return addresses, it also prevents the processor from exploiting any valid return addresses that are held in the link return stack along with the invalid entries.

### SUMMARY OF THE DISCLOSURE

The present invention comprises a method and apparatus for managing a link return stack used for storing branch return addresses based on partially invalidating the link return stack responsive to detecting a mispredicted branch. In at least one embodiment, partially invalidating the link return stack comprises invalidating entries in the link return stack that are dependent on the mispredicted branch, and resetting the link return stack to a remaining valid entry. Doing so provides the microprocessor with the branch return performance improvements gained by retaining the valid branch return addresses remaining in the link return stack, while avoiding the power consumption the processor otherwise would waste by accessing its instruction cache at the invalid branch return addresses.

Thus, in one embodiment, a method of managing a link return stack comprises storing branch return addresses as entries in the link return stack, determining that one or more entries in the link return stack are invalid because of a branch misprediction, and resetting the link return stack to a valid remaining entry. Determining that one or more entries in the link return stack are invalid because of a branch misprediction may comprise determining that an entry in the link return stack directly and/or indirectly depends on a mispredicted branch. The method, or variations of it, may be implemented in a processor, such as a Reduced Instruction Set Computer (RISC) processor, including a link return stack circuit comprising a link return stack and a link return stack controller.

For actual stack-based configurations of the link return stack, resetting the link return stack to a valid remaining entry may comprise popping previously pushed entries off of the stack until all invalid entries are removed from the stack and a valid remaining return address is the topmost stack entry, or is the entry otherwise pointed to by a stack index pointer (e.g., a “read” pointer used to access the stack). In other link return stack configurations, such as in an indexed circular buffer arrangement, the index values of the buffer's read/write pointers can be incremented or decremented as needed to invalidate entries in the buffer that depend on a mispredicted branch, and to reset the buffer to a valid remaining entry, if any.

Regardless of stack implementation details, the link return stack controller generally can be configured to partially invalidate the link return stack responsive to detecting a mispredicted branch and recognizing that the misprediction invalidates one or more entries in the link return stack. In at least one embodiment, the link return stack controller includes or is associated with a marking circuit that marks in an associated branch information queue which predicted branches have corresponding branch return addresses stored as entries in the link return stack. Thus, the link return stack controller can be configured to recognize that a mispredicted branch has a corresponding branch return address stored as an entry in the link return stack by detecting that the mispredicted branch is marked in the branch information queue. The branch information queue also may be used to store the index value corresponding to the particular link return stack location at which the branch return address was written for each marked branch, and the link return stack controller can use the index value in determining which stack entry or entries must be invalidated.

In one or more other embodiments, the link return stack controller is configured to recognize that a branch misprediction invalidates one or more stack entries directly or indirectly. For example, even where the mispredicted branch does not have a corresponding entry in the link return stack—e.g., it was not a branch-and-link instruction-one or more predicted branches that logically follow the mispredicted branch may have entries in the link return stack made invalid because of the misprediction. Thus, the link return stack controller can be configured to evaluate the branch information queue responsive to detecting a branch misprediction, to determine whether any entries in the link return stack are invalid as being directly or indirectly dependent on the mispredicted branch.

### BRIEF DESCRIPTION OF THE DRAWINGS

FIG. 1 is a block diagram illustrating a microprocessor, including a link return stack circuit.

FIG. 2 is a logic flow diagram illustrating a method of partially invalidating the link return stack illustrated for the processor of FIG. 1.

FIG. 3 is a block diagram of one embodiment of a link return stack circuit and one or more associated circuits.

FIG. 4 is a program instruction flow diagram illustrating successive predicted program branches.

FIGS. 5-7 are block diagrams of a return stack having branch return addresses successively stored in it, corresponding to the successive predicted program branches of FIG. 4.

FIG. 8 is a block diagram of the return stack of FIGS. 5-7 after a partial invalidation responsive to a branch misprediction.

FIG. 9 is a logic flow diagram illustrating a method of partially invalidating a link return stack, based on evaluating the Branch Information Queue (BIQ) illustrated in FIG. 3.

FIG. 10 is a logic flow diagram illustrating another method of partially invalidating a link return stack, based on evaluating the Branch Information Queue (BIQ) illustrated in FIG. 3.

### DESCRIPTION OF EMBODIMENTS OF THE INVENTION

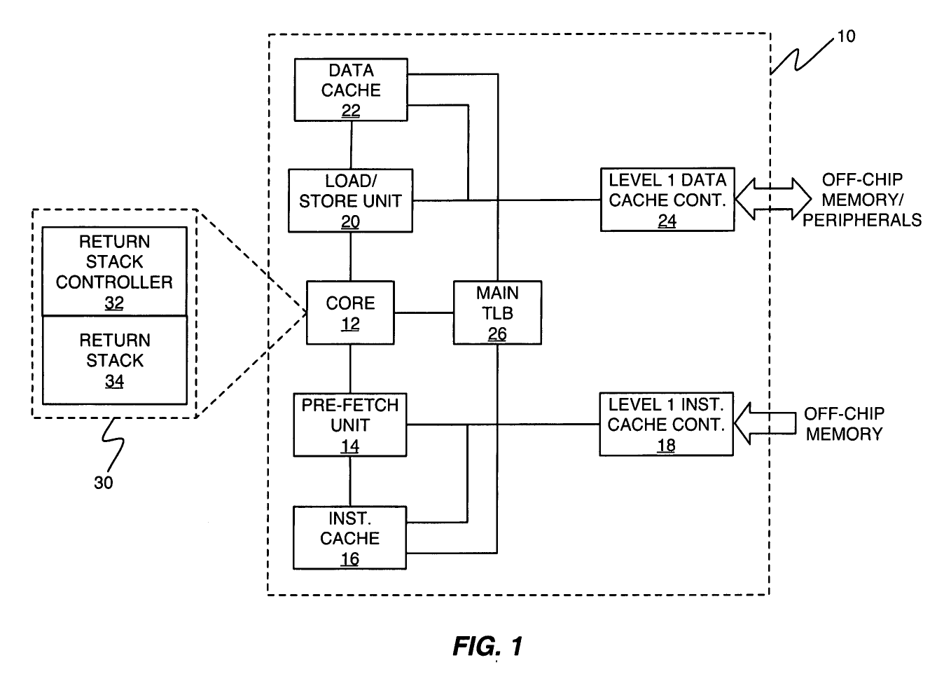

FIG. 1 at least partially illustrates a microprocessor 10 comprising a processor core 12, an instruction pre-fetch unit 14, an instruction cache 16, an instruction cache controller 18, a load/store unit 20, a data cache 22, a data cache controller 24, and a main translation lookaside buffer 26. In at least one embodiment, the processor 10 includes a link return stack circuit 30 comprising a link return stack controller 32 and a link return stack 34 (e.g., registers or other memory locations). By way of non-limiting example, the microprocessor 10 may be a pipelined processor based on a Reduced Instruction Set Computer (RISC) architecture.

In one or more embodiments, the core 12 includes an instruction execution unit (not shown) comprising one or more multi-stage instruction pipelines. In operation, the core 12 executes program instructions and carries out corresponding load/store data operations. The translation lookaside buffer 26 accepts inputs from the core 12 and provides outputs to the core 12. More particularly, the translation lookaside buffer 26 interfaces the core 12 to the instruction and data caches 16 and 22, respectively. The instruction and data caches 16 and 22 comprise fast, on-board memory, and the microprocessor 10 uses instruction and data pre-fetching via the instruction and data cache controllers 18 and 24 to keep the caches filled with the next-needed instructions and data.

In one aspect of instruction pre-fetching, the processor 10 uses the link return stack circuit 30 to accelerate the processor's return from procedure calls. As such, the link return stack controller 32 generally is configured to push each procedure call's return address onto the link return stack 34. Then, when a procedure return is recognized, the return address is popped from the link return stack 34 and provided to the pre-fetch unit 14 as the predicted return address for instruction pre-fetching.

Because the return addresses stored in the link return stack 34 may correspond to conditional branches that are “predicted” as taken by the processor's branch prediction unit before the branch condition actually is evaluated, branch mispredictions generally cause one or more entries in the link return stack 34 to be invalid. For example, the entry in the link return stack 34 corresponding to a predicted taken branch is invalid if that prediction turns out to be wrong. Further, entries in the link return stack 34 that are written after the mispredicted branch's entry was written generally are also invalid. That is, the mispredicted branch's entry, and any “newer” or “younger” entries in the link return stack 34, all depend on the mispredicted branch and are therefore invalid.

However, any entries older than the first entry dependent on the mispredicted branch are not invalidated by the branch misprediction and therefore are still useful in accelerating procedure returns. In accordance with one or more embodiments, the link return stack controller 32 of the processor 10 is configured to “salvage” these remaining valid entries in the link return stack 34 by partially invalidating the link return stack 34 in response to detecting that it contains one or more invalid entries arising from a branch misprediction. If the link return stack controller 32 invalidated the whole link return stack 34 in such instances, it would forfeit the performance gains otherwise available from using the remaining valid entries. On the other hand, if the link return stack controller 32 simply ignored the invalid entries, power would be wasted by pre-fetching instructions from the wrong return addresses.

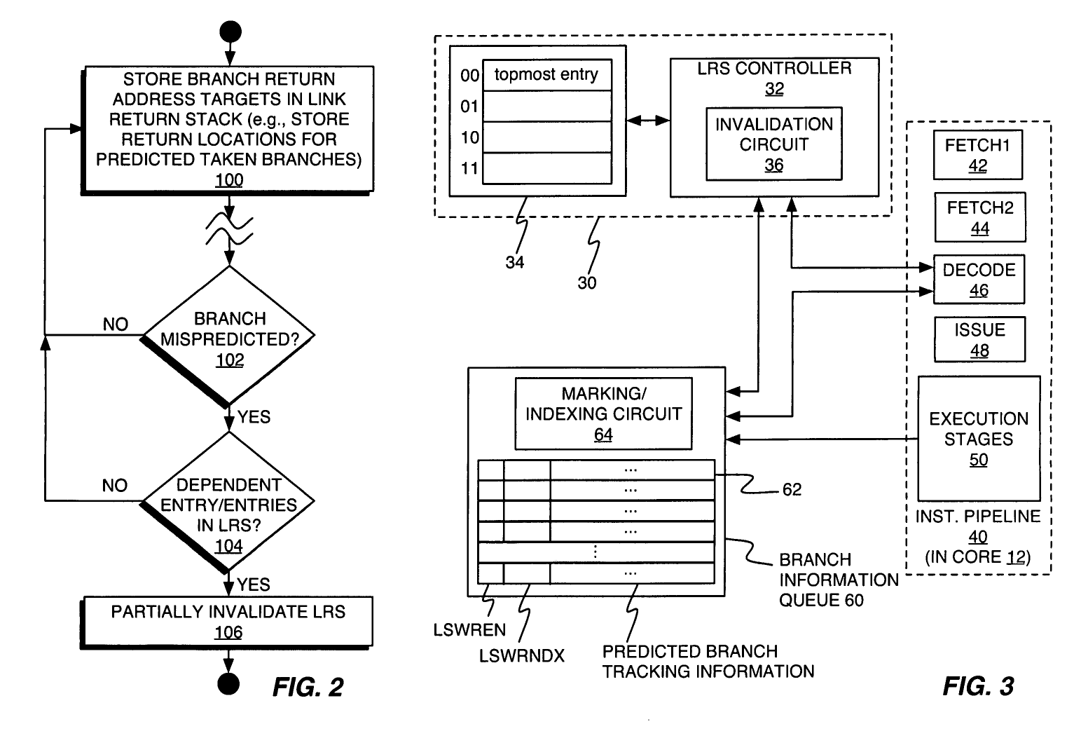

FIG. 2 illustrates one embodiment of program logic supporting partial link return stack invalidation operations by the link return stack controller 32. Generally, an instruction decode unit in the instruction pipeline of the processor 10 provides the link return stack controller 32 with return addresses corresponding to the predicted taken program branches as part of the processor's branch prediction operations carried out during program execution. Thus, processing “begins” in FIG. 2, with the link return stack controller 32 storing branch return addresses on the link return stack 34 as part of ongoing program execution (Step 100). It should be understood that this step of storing (and retrieving) return addresses from the link return stack 34 represents an ongoing activity of the link return stack controller 32.

In the illustrated logic flow, the ongoing storing and retrieving of return addresses from the link return stack 34 is interrupted responsive to the detection of a branch misprediction. The link return stack controller 32 may detect branch mispredictions directly, or may detect them indirectly based on that condition being signaled to it via another circuit in the processor's core 12. For example, in at least one embodiment, the processor's instruction pipeline execute unit signals branch mispredictions to the link return stack controller 32.

If a branch misprediction is detected (Step 102), the link return stack controller 32 determines whether there are any dependent entries stored in the link return stack 34 (Step 104). If so, the link return stack controller 32 partially invalidates the link return stack 34 (Step 106). In at least one embodiment of the link return stack circuit 30, “partially invalidating” the link return stack 34 comprises recognizing that a mispredicted branch has a corresponding branch return address stored as an entry in the link return stack 34, identifying that entry and any newer entries in the link return stack 34, and considering those identified entries as invalid. With the invalid entries thus determined, the link return stack controller “resets” the link return stack 34 to a valid remaining entry, if any.

If the link return stack 34 is implemented as an actual memory stack that is sequentially pushed and popped, resetting the link return stack 34 may comprise popping entries from the link return stack 34 until all invalid entries are removed and a valid return address is the topmost stack entry. Of course, if stack pointers are used, the “topmost” entry is whatever entry the stack (read) pointer points to, and, in such cases, resetting the link return stack 34 to a remaining valid entry may comprise adjusting the stack pointer to a remaining valid entry.

Similarly, if the link return stack 34 is implemented as a circular buffer having indexed buffer positions accessed via read/write pointers, resetting the link return stack 34 may comprise rolling back the read pointer to a remaining valid entry in the circular buffer. More particularly, the read pointer may be rolled back to the newest valid entry remaining in the stack after invalidation of the entries dependent on the branch misprediction. (If a separate write pointer is used, it may be set to one buffer position beyond that newest valid entry, such that the invalidated entries are overwritten as subsequent return addresses are stored in the link return stack 34.) With such variations in mind, those skilled in the art will recognize that the actual manipulations needed to reset the link return stack 34 to a valid remaining entry depend on the stack implementation and thus will vary as needed or desired.

Indeed, the link return stack controller's ability to identify invalid entries in the link return stack 34 based on their dependency on a mispredicted branch is of more interest than the mechanics of manipulating stored entries in the link return stack 34 itself. FIG. 3 illustrates one embodiment of elements that may be implemented in the processor 10 in support of such identification. More particularly, the illustration depicts one embodiment of the link return stack circuit 30, comprising the previously illustrated link return stack controller 32 and link return stack 34, and wherein the link return stack controller 32 functionally includes an invalidation circuit 36 that is configured to carry out partial invalidation of the link return stack 34.

Also illustrated is an embodiment of the core's instruction pipeline 40, including, by way of non-limiting example, instruction fetch stages 42 and 44, an instruction decode stage 46, an instruction issue stage 48, and one or more instruction execution stages 50. Note that other pipeline configurations, including superscalar configurations, are contemplated herein. Finally, FIG. 3 illustrates the inclusion of a Branch Information Queue (BIQ) 60 that, in the illustrated embodiment, includes a branch table 62 and a marking/indexing circuit 64.

In operation, the branch table 62, which may comprise an association of memory registers or the like, is used to track various information items for all unresolved program branches—i.e., for all program branches whose taken-or-not-taken conditions have not been resolved. The branch table 62 thus carries information for tracking pending predicted branches. According to one or more methods of partially invalidating the link return stack 34, the information stored in the branch table 62 includes an indicia or other “marking” for each branch entry in the table 62 that indicates whether that branch has a corresponding entry in the link return stack 34.

The marking/indexing circuit 64 may thus set or clear a “Link Stack Write Enable” (LSWREN) flag—e.g., a single-bit indicator—for each branch entry in the table 62, to indicate whether the predicted program branch represented by that table entry had a corresponding return address written into the link return stack 34. (Note that the marking/indexing circuit 64 may not be implemented separately, but rather may be functionally included within the decode stage 46 and/or within the link return stack controller 32, such that LSWREN indicators are set/cleared in the branch table 62 in conjunction with managing the other branch information in each table entry.)

With LSWREN or similar indicators included in the branch table 62, the link return stack controller 32 can evaluate the branch table 62 in response to detecting a branch misprediction, to determine whether mispredicted branches are flagged as having corresponding return address entries in the link return stack 34. In one embodiment, the link return stack controller 32 does not partially invalidate the link return stack 34 unless the mispredicted branch is flagged in the branch table 62 as having a return address entry in the link return stack 34.

If a mispredicted branch is flagged in the branch table 62 as having an entry in the link return stack 34, the link return stack controller 34 can be configured to identify that corresponding entry's specific location in the link return stack 34 based on reading a position indicator value—e.g., an index value—from the mispredicted branch's table entry. Thus, in one or more embodiments, a “Link Stack Write Index” (LSWRNDX) value is stored in conjunction with the LSWREN flag, indicating the position in the link return stack 34 at which the mispredicted branch's return address was written. By way of non-limiting example, a four-deep configuration of the link return stack 34 may be indexed using two bits to identify the four stack positions as 00, 01,10, and 11.

Thus, if a branch misprediction occurs, the link return stack controller 32 can directly or indirectly inspect the entries in the branch table 62 to determine whether the mispredicted branch has its LSWREN indicator set or cleared. If the LSWREN indicator is set, the link return stack controller 32 can then read the corresponding LSWRNDX value to locate the mispredicted branch's return address entry in the link return stack 34. With the mispredicted branch's return address entry in the link return stack 34 so identified, the link return stack controller 32 can invalidate that entry, and any newer entries, in the link return stack 34. Of course, if no valid entries remain in the link return stack 34 after such operations, the link return stack controller 32 can simply treat the link return stack 34 as an empty stack having no valid return addresses.

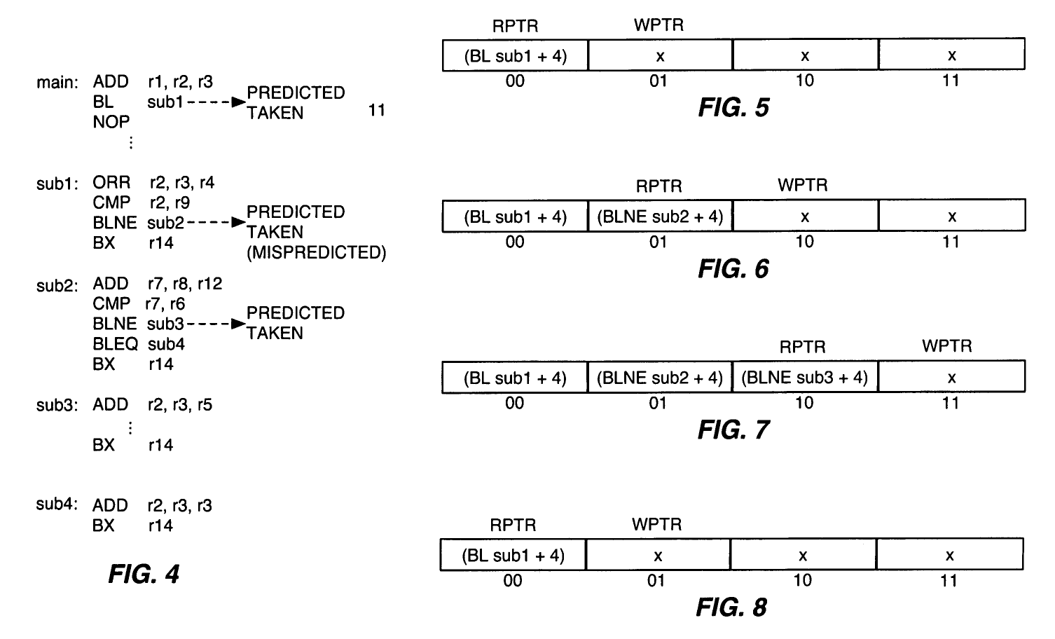

To illustrate at least one practical embodiment of the above operations, one may refer to the example excerpt of program code illustrated in FIG. 4. A “main” program includes a branch-and-link instruction to the procedure “sub1,” denoted as “BL sub1.” That branch is unconditional and therefore is predicted as taken, causing the return address of the “BL sub1” instruction to be written to the previously empty/invalid link return stack 34. The results of that operation are shown in FIG. 5, for a four-deep configuration of the link return stack 34.

As shown, the first index position (00) of the link return stack 34 holds the return address of the “BL sub1” instruction. Assuming 4-byte instructions, the return address will be the address of the instruction just after the BL sub1 procedure call, and thus is given as (BL sub1+4). The read pointer (RPTR) of the link return stack 34 is set to the 00 index position, and the write pointer (WPTR) is advanced one position ahead to the 01 index position.

Referring again to FIG. 4, one sees that the sub1 procedure includes a conditional branch to a procedure named “sub2.” If one assumes that the sub2 conditional branch is predicted taken, then the link return stack controller 32 stores the return address for the “BLNE sub2” instruction on the link return stack 34. FIG. 6 illustrates the state of the link return stack 34 after that store is performed.

Continuing along the program execution flow according to the branch predictions, one sees that the sub2 procedure includes a conditional branch to a procedure named “sub3.” Assuming that the sub3 branch is predicted as taken, the link return stack controller 32 writes the return address for the sub3 procedure onto the link return stack 34, which now holds the return addresses for the sub1 branch, the sub2 branch, and the sub3 branch, all in sequence. This condition is illustrated in FIG. 7.

Now, assuming that the execution stage(s) 50 of the instruction pipeline 40 determine that the sub2 branch was mispredicted—i.e., the “BLNE sub2” condition turned out not to be satisfied—one sees that the link return stack 34 holds invalid return addresses at its 01 and 10 index positions. That is, the (BL sub1+4) return address held in the 00 position was stored before the misprediction of the sub2 branch, so it is still a valid return address, but the (BLNE sub2+4) return address held in the 01 position and the (BLNE sub3+4) address held in the 10 position are both invalid as being dependent on the misprediction of the sub2 branch.

Thus, the link return stack controller 32 detects the misprediction of the sub2 branch, which may be signaled by the execution stage(s) 50, finds the sub2 branch's entry in the branch table 62 of BIQ 60, determines that the sub2 branch's LSWREN flag is set, and then uses the value of the corresponding LSWRNDX to determine the index position in the link return stack 34 that holds the return address for the sub2 branch—i.e., the 01 position. The link return stack controller 32 identifies that entry, and the newer entry for the sub3 branch held in the 10 position, as being invalid, and thus partially invalidates the link return stack 34 by resetting its read pointer to the newest valid entry remaining in the link return stack 34—i.e., the sub1 branch return address held in the 00 position. In conjunction, the link return stack controller 32 may reset the write pointer to the next position after the read pointer, which will cause the invalidated entries to be overwritten by subsequent writes to the link return stack 34.

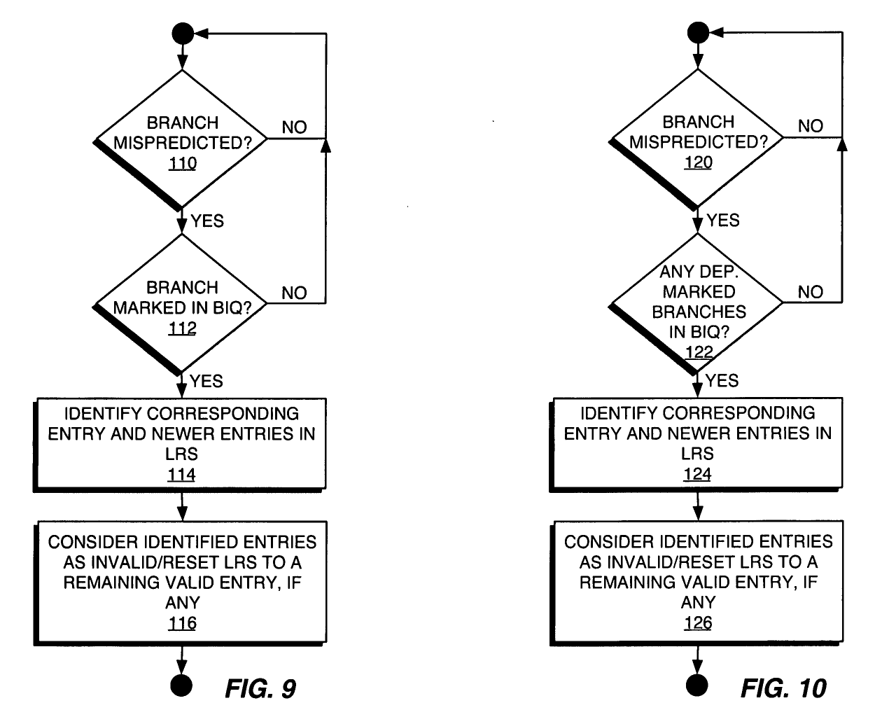

FIG. 9 encapsulates the above partial invalidation operations by illustrating that one embodiment of partial invalidation begins with the detection of a branch misprediction (Step 110), followed by a determination of whether the mispredicted branch is marked in the BIQ 60 as having a corresponding return address stored in the link return stack 34 (Step 112). In the illustrated embodiment, if the mispredicted branch is not marked, partial invalidation is not performed. This simplifies evaluation of the branch table 62 in the BIQ 60 because the link return stack controller 32 need only determine whether the mispredicted branch is or is not marked in the branch table 62 as having a return address entry in the link return stack 34.

If the mispredicted branch is so marked, then the link return stack controller 32 identifies its corresponding entry—e.g., using the corresponding LSWRNDX value—and any newer entries held in the link return stack 34 (Step 114). Those identified entries are considered by the link return stack controller 32 as being invalid (Step 116), and partial invalidation of the link return stack 34 is performed accordingly.

At the expense of increased evaluation complexity, the link return stack controller 32 can be configured to perform partial invalidation on a more sophisticated basis. For example, one embodiment of partial invalidation is not limited to triggering partial invalidation operations only if the mispredicted branch is marked in the branch table 62. More generally, the partial invalidation method may use the table 62 and/or other mechanisms to determine that one or more entries in the link return stack 34 are invalid because of a branch misprediction. Broadly, this involves the link return stack controller 32 determining that one or more entries in the link return stack 34 comprise branch return addresses that are in some way dependent upon a mispredicted branch. As such, the link return stack controller 32 may employ one or more mechanisms to determine that a given mispredicted branch has a corresponding entry in the link return stack 34, or that one or more entries in the link return stack 34 correspond to predicted branches that logically follow the mispredicted branch.

FIG. 10 illustrates one embodiment of that more generalized approach to partial invalidation, wherein, if a branch is detected as mispredicted (Step 120), the link return stack 34 determines whether the mispredicted branch is marked in the branch table 62, and further determines whether any predicted branches dependent on the mispredicted branch are marked in the branch table 62 (Step 122). In other words, even if the mispredicted branch itself does not have a return address stored for it in the link return stack 34, one or more predicted branches that logically depend on it may have such entries.

The link return stack controller 32 identifies such entries in the link return stack 34, and any newer entries in the link return stack 34 (Step 124), and performs partial invalidation based on considering those identified entries as being invalid (Step 126). The link return stack 34 is thus reset to a remaining valid entry, if any.

Those skilled in the art should recognize that the partial invalidation method described immediately above, and those described elsewhere herein, stand as non-limiting embodiments of a broader method of partially invalidating link return stacks, so that return addresses in the stack not made invalid by a given branch misprediction are retained, with the attendant performance and power advantages discussed herein. Moreover, those skilled in the art will appreciate that link stack return management as taught herein may be adapted to a wide range of microprocessor architectures beyond those illustrated herein. As such, the present invention is not limited by the foregoing discussion, nor is it limited by the accompanying drawings. Rather, the present invention is limited only by the following claims and their legal equivalents.

What is claimed is:

1. A method of managing a link return stack comprising:
storing branch return addresses as entries in the link return stack; and
determining that one or more entries in the link return stack are invalid because of a branch misprediction and resetting the link return stack to a valid remaining entry.

2. The method of claim 1, wherein determining that one or more entries in the link return stack are invalid because of a branch misprediction comprises determining that one or more entries in the link return stack comprise branch return addresses that are dependent on a mispredicted branch.

3. The method of claim 2, wherein determining that one or more entries in the link return stack comprise branch return addresses that are dependent on a mispredicted branch comprises determining that the mispredicted branch has a corresponding entry in the link return stack, or that one or more entries in the link return stack correspond to predicted branches that logically follow the mispredicted branch.

4. The method of claim 1, wherein determining that one or more entries in the link return stack are invalid because of a branch misprediction comprises recognizing that a mispredicted branch has a corresponding branch return address stored as an entry in the link return stack, identifying that entry and any newer entries in the link return stack, and considering those identified entries as invalid.

5. The method of claim 4, wherein recognizing that a mispredicted branch has a corresponding branch return address stored as an entry in the link return stack comprises marking in a branch information queue which predicted branches have corresponding branch return addresses stored as entries in the link return stack, and detecting that the mispredicted branch is so marked in said branch information queue.

6. The method of claim 5, wherein identifying the mispredicted branch's entry in the link return stack comprises storing link return stack index values for the marked predicted branches in the branch information queue, and using the link return stack index value stored in the buffer information queue for the mispredicted branch to identify its corresponding entry in the link return stack, and to identify any newer entries in the link return stack.

7. The method of claim 1, wherein storing branch return addresses as entries in the link return stack comprises implementing the link return stack as a circular buffer, successively writing branch return addresses into the circular buffer, and generally maintaining a read pointer for the circular buffer such that it points to the last entry written into the circular buffer.

8. The method of claim 7, wherein resetting the link return stack to a valid remaining entry comprises adjusting the read pointer for the circular buffer such that it points to the newest valid entry remaining in the circular buffer.

9. The method of claim 1, wherein storing branch return addresses as entries in the link return stack comprises successively pushing branch return addresses onto the link return stack, and generally maintaining a read pointer for the link return stack such that it points to the topmost entry on the link return stack.

10. The method of claim 9, wherein resetting the link return stack to a valid remaining entry comprises popping one or more entries from the link return stack, such that the topmost entry on the link return stack is the newest valid entry remaining in the link return stack.

11. A link return stack circuit for use in a microprocessor, the link return stack circuit comprising:
a link return stack configured to store a plurality of return addresses; and
a link return stack controller generally configured to store branch return addresses as entries in the link return stack, and particularly configured to determine that one or more entries in the link return stack are invalid because of a branch misprediction and reset the link return stack to a valid remaining entry.

12. The link return stack circuit of claim 11, wherein the link return stack controller is configured to determine that one or more entries in the link return stack are invalid because of a branch misprediction based on determining that one or more entries in the link return stack comprise branch return addresses that are dependent on a mispredicted branch.

13. The link return stack circuit of claim 12, wherein the link return stack controller is configured to determine that one or more entries in the link return stack comprise branch return addresses that are dependent on a mispredicted branch by determining that the mispredicted branch has a corresponding entry in the link return stack, or that one or more entries in the link return stack correspond to predicted branches that logically follow the mispredicted branch.

14. The link return stack circuit of claim 11, wherein the link return stack controller is configured to determine that one or more entries in the link return stack are invalid because of a branch misprediction based on recognizing that a mispredicted branch has a corresponding branch return address stored as an entry in the link return stack, identifying that entry and any newer entries in the link return stack, and considering those identified entries as invalid.

15. The link return stack circuit of claim 14, wherein the link return stack controller includes or is associated with a marking circuit that marks in an associated branch information queue which predicted branches have corresponding branch return addresses stored as entries in the link return stack, and wherein the link return stack controller is configured to recognize that a mispredicted branch has a corresponding branch return address stored as an entry in the link return stack based on the link return stack controller detecting that the mispredicted branch is so marked in said branch information queue.

16. The link return stack circuit of claim 15, wherein the marking circuit is configured to store link return stack index values for the marked predicted branches in the branch information queue, and wherein the link return stack controller is configured to use the link return stack index value stored in the buffer information queue for the mispredicted branch to identify its corresponding entry in the link return stack, and to identify any newer entries in the link return stack.

17. The link return stack circuit of claim 11, wherein the link return stack is a circular buffer, and wherein the link return stack controller is configured to store branch return addresses as entries in the link return stack by successively writing branch return addresses into the circular buffer, and is configured generally to maintain a read pointer for the circular buffer such that it points to the last entry written into the circular buffer.

18. The link return stack circuit of claim 17, wherein the link return stack controller is configured to reset the link return stack to a valid remaining entry by adjusting the read pointer for the circular buffer such that it points to the newest valid entry remaining in the circular buffer.

19. The link return stack circuit of claim 11, wherein the link return stack controller is configured to store branch return addresses as entries in the link return stack by successively pushing branch return addresses onto the link return stack, and is configured generally to maintain a read pointer for the link return stack such that it points to the topmost entry on the link return stack.

20. The link return stack circuit of claim 19, wherein the link return stack controller is configured to reset the link return stack to a valid remaining entry by popping one or more entries from the link return stack, such that the topmost entry on the link return stack is the newest valid entry remaining in the link return stack.

21. A method of managing a link return stack comprising:
storing branch return addresses as entries in the link return stack in association with predicting program branches; and
partially invalidating the link return stack responsive to detecting a mispredicted branch having one or more dependent entries in the link return stack.

22. A method of managing a link return stack comprising:
storing branch return addresses as entries in the link return stack in association with predicting program branches;
invalidating any dependent entries in the link return stack responsive to detecting a branch misprediction; and
resetting the link return stack to a valid entry, if any, remaining in the link return stack.

23. A processor including a link return stack and a link return stack controller, said link return stack controller configured to store branch return addresses as entries in the link return stack, and further configured to determine that one or more entries in the link return stack are invalid because of a branch misprediction and reset the link return stack to a valid remaining entry.

24. The processor of claim 23, wherein the processor is configured to track predicted branches in a branch information queue, and to mark which ones of the predicted branches have corresponding branch return addresses stored as entries in the link return stack, and wherein the link stack controller is configured to determine that a mispredicted branch has a corresponding entry in the link return stack based on said markings in the branch information queue.

25. The processor claim 24, wherein the processor is further configured to store a link return stack index value in the branch information queue for each marked predicted branch, and wherein the link return stack controller identifies the entry in the link return stack corresponding to the mispredicted branch based on the link return stack index value stored for the mispredicted branch.
